(19) United States
(12) Patent Application Publication
(10) Pub. No.: US 2009/0037105 A1
(43) Pub. Date: Feb. 5, 2009

(54) Positioning Device and Positioning Method for a Satellite Navigation System

(75) Inventors: Jan M. W. KRUEGER, Munich (DE); Hans L. TRAUTENBERG, Ottobrunn (DE)

Correspondence Address: CROWELL & MORING LLP;INTELLECTUAL PROPERTY GROUP, P.O. BOX 14300, WASHINGTON, DC, 20044-4300, US

(73) Assignee: Astrium GmbH, Munich (DE)

(21) Appl. No.: 12/182,697

(22) Filed: Jul. 30, 2008

(30) Foreign Application Priority Data
Aug. 1, 2007 (DE) 102007036497.2-35

(51) Int. Cl. G01C 21/00

(52) U.S. Cl. 701/214

(57) ABSTRACT

A positioning device for a satellite navigation system includes a receiver that receives atmospheric correction data and an evaluation unit that determines a position location and estimates its quality on the basis of a plurality of positioning signals, with inclusion of the atmospheric correction data.

### CROSS REFERENCE TO RELATED APPLICATIONS

This application which claims priority under 35 U.S.C. § 119 to German Patent Application No. 10 2007 036 497.2-35, filed Aug. 1, 2007, the entire disclosure of which is herein expressly incorporated by reference.

### BACKGROUND AND SUMMARY OF THE INVENTION

The invention relates to a positioning device and a corresponding positioning method which are suitable for use in satellite navigation systems.

Global Navigation Satellite Systems (GNSS) are used for position determination and navigation on the earth and in the air. GNSS systems, such as the European Satellite Navigation System currently under construction (referred to below as “Galileo system” or “Galileo” for short), have a satellite system comprising a plurality of satellites, an earth-based receiver system connected to a central computation station, and utilization systems that evaluate and use the satellite signals transmitted by the satellites.

For positioning, i.e., position determination and/or navigation, the utilization systems receive and evaluate signals from multiple satellites. The signals, in particular their propagation times, may be altered due to influence by the atmosphere. This has an adverse effect on the positioning accuracy.

The tropospheric component represents one error component of GNSS distance measurements which at the present time is difficult to correct. This component results in particular from small-scale localized differences in air pressure and humidity. In the troposphere the influence of the signal propagation time is independent of the frequency, and therefore cannot be determined using a dual-frequency measurement system, as is the case in the ionosphere. The troposphere may be modeled on a global basis. However, global tropospheric models have large modeling errors. For modern GNSS systems these have become the largest error component. It is doubtful whether global tropospheric models can attain the reliability necessary for integrity systems. This reliability may be achievable for large-scale alarm barriers, but represents an unsolved problem for systems having alarm barriers in the range of 20 m.

Exemplary embodiments of the present invention involve a positioning device and a positioning method for a satellite navigation system that provide more accurate positioning.

One aspect of the invention involves transmitting atmospheric corrections in near-real time to a positioning device for a satellite navigation system to allow more accurate positioning. This approach allows the tropospheric error component, for example, which represents the largest source of error in current dual-frequency GNSS systems, to be reduced outside localized augmentation systems by orders of magnitude. Exemplary embodiments of the present invention achieve particularly great reductions in the error caused by the troposphere when there are large deviations from standard conditions. Of course, the mean error will also likely be consistently reduced. The tropospheric error budget for security-critical applications may be reduced considerably by the reduction in large tropospheric deviations. This allows efficient use to be made of existing or future communication bandwidths for improved service. This is very advantageous for GNSS users, and opens up great advantages and business opportunities for operators.

According to one aspect, the present invention relates to a positioning device for a satellite navigation system, comprising
a receiver that receives atmospheric correction data and
an evaluation unit that determines a position location and estimates its quality on the basis of a plurality of positioning signals, with inclusion of the atmospheric correction data.

The evaluation unit may use the atmospheric correction data to compensate for error components of the positioning signals caused by atmospheric influences. This allows much more precise positioning to be performed, and the estimation of the probability of position solutions with errors above a given barrier limit results in much lower probabilities.

The atmospheric correction data may contain instantaneous air pressure and/or humidity data from the troposphere. This allows the positioning signals to be corrected for interferences caused by air pressure or humidity. The data may be locally measured data, as well as data from models of the spatial and temporal characteristics of the air pressure, humidity, and/or temperature.

The receiver may receive the atmospheric correction data via a transmission channel which is suitable for transmitting at least one of the plurality of positioning signals. Therefore, an additional transmission channel for the atmospheric correction data is not necessary.

Useful data may be transmitted via the plurality of positioning signals, and the atmospheric correction data may be transmitted via at least one of the plurality of positioning signals. This allows the atmospheric correction data to be compactly embedded in the positioning signals.

The positioning device may have a memory that stores an atmospheric model, and an adjustment unit that adjusts the atmospheric model on the basis of the atmospheric correction data and provides an adjusted atmospheric model to the evaluation unit, and the evaluation unit may determine the position location with inclusion of the adjusted atmospheric model. Storage of the atmospheric model allows the atmospheric correction data which is to be transmitted to be reduced to the essential data necessary for adjusting the stored model.

The positioning device may also have an air pressure sensor that detects localized air pressure and/or humidity data, and the evaluation unit may determine the position location with inclusion of the localized air pressure and/or humidity data. The atmospheric correction data may be further supplemented by use of the air pressure sensor. The air pressure sensor also allows more accurate positioning, even when no atmospheric correction data are available.

According to another aspect, the present invention relates to a system for navigation or position determination, comprising
a plurality of transmitters that emit positioning signals; and
at least one of the aforementioned positioning device according to an embodiment of the present invention.

According to another aspect, the present invention relates to a positioning method for a satellite navigation system, comprising the following steps:
receiving atmospheric correction data; and
determining a position location from a plurality of positioning signals, with inclusion of the atmospheric correction data.

According to a further aspect, the present invention relates to a computer program for carrying out a positioning method according to an embodiment of the present invention, and a computer program product containing a machine-readable program medium on which a computer program according to an embodiment of the present invention is stored in the form of electronically and/or optically readable control signals.

Other objects, advantages and novel features of the present invention will become apparent from the following detailed description of the invention when considered in conjunction with the accompanying drawings.

### BRIEF DESCRIPTION OF THE DRAWINGS

Further advantages and application possibilities of the present invention result from the following description in conjunction with the exemplary embodiment illustrated in the single drawing. The single drawing shows a positioning device according to one exemplary embodiment of the present invention.

Identical and/or functionally equivalent elements may be provided with the same reference numerals in the discussion below. The absolute values and dimensions stated below are by way of example only, and do not limit the invention to such dimensions.

### DETAILED DESCRIPTION OF THE DRAWINGS

The figure shows a system for position determination or navigation, which according to one exemplary embodiment of the present invention comprises a positioning device 100 and transmitters 102, 104, 106. The system may be a GNSS system, such as, for example, the Galileo system. In this case the transmitters 102, 104, 106 may be satellites, and the positioning device 100 may be a utilization system or terminal which allows positioning on the earth or in the air. For this purpose the transmitters 102, 104, 106 may be designed to emit positioning signals. The positioning signals may be received and used by the positioning device 100 to determine and provide a position location of the positioning device 100. In addition, at least one of the transmitters 102, 104, 106 transmits atmospheric correction data. Alternatively, the atmospheric correction data may be transmitted by an additional transmitter which does not transmit a positioning signal.

The number of transmitters 102, 104, 106 is illustrated here only as an example. For example, at the time of the positioning the positioning device 100 may require positioning signals from more than the three different transmitters 102, 104, 106 shown in order to carry out the positioning.

The positioning device 100 has a receiver 112 and an evaluation unit 114. The receiver 112 receives the atmospheric correction data. The receiver may also receive the positioning signals from the transmitters 102, 104, 106. The evaluation unit 114 determines and provides a position location of the positioning device 100 on the basis of the positioning signals, with inclusion of the atmospheric correction data.

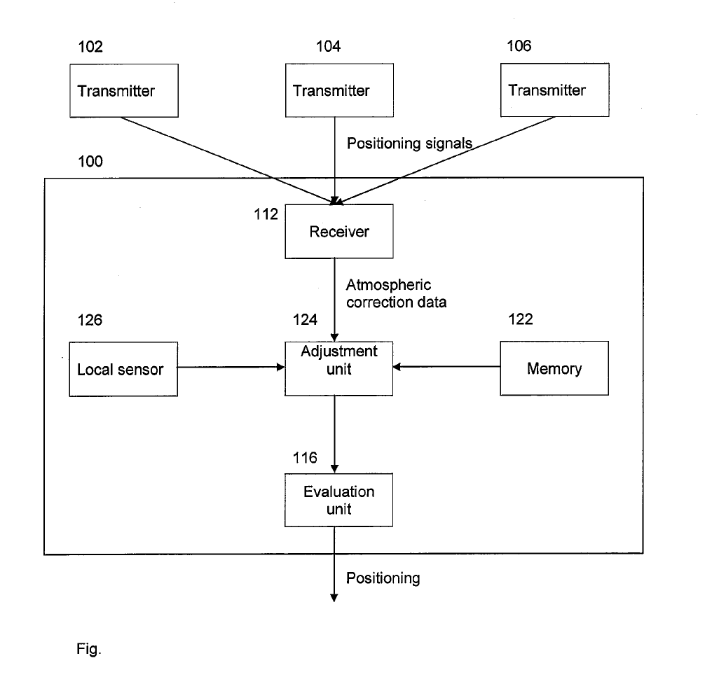

The receiver 112 may receive the atmospheric correction data via a transmission channel which is suitable for transmitting at least one of the pluralities of positioning signals. For example, the atmospheric correction data may be transmitted via at least one of the plurality of positioning signals, the receiver 112 receiving the at least one positioning signal via which the atmospheric correction data are transmitted. The atmospheric correction data may be embedded in the at least one positioning signal. Alternatively, the atmospheric correction data may be transmitted, and received by the receiver 112, separately from the positioning signals. The receiver 112 provides the atmospheric correction data and the positioning signals to the evaluation unit 114, when the positioning signals are received by the receiver 112. If the positioning signals are not received by the receiver 112, the positioning device may have an additional receiver (not shown in FIG. 1) for receiving the positioning signals.

The evaluation unit 114 determines the position location of the positioning device 100 on the basis of the positioning signals provided. The evaluation unit 114 determines the position location, taking the received atmospheric correction data into account. The evaluation unit 114 may execute a predetermined algorithm by means of which the position location may be determined from the positioning signals and the atmospheric correction data.

According to one aspect, the positioning device 100 has a memory 122 in which an atmospheric model may be stored. The atmospheric model may be used by the evaluation unit 114 to achieve more accurate positioning. Even more accurate positioning may be achieved when the atmospheric model is adjusted or corrected using the atmospheric correction data. To this end, the positioning device 100 may have an adjustment unit 124 which is designed to adjust or correct the stored atmospheric model on the basis of the atmospheric correction data, and to provide the adjusted atmospheric model to the evaluation unit 114. The evaluation unit 114 may determine the position location, taking the adjusted atmospheric model into account. Units 116 and 124 can be implemented using one or more processors, such as a microprocessor, field programmable gate array (FPGA), application specific integrated circuit (ASIC), and/or the like.

This allows the evaluation unit 114 to compensate for error components of the positioning signals caused by atmospheric influences, using the adjusted atmospheric model. According to one exemplary aspect, the atmospheric correction data contain instantaneous air pressure, humidity, and/or temperature data from the troposphere.

According to further exemplary aspects, the positioning device 100 has a local sensor 126. The local sensor 126 may measure air pressure, humidity, and/or temperature which is/are localized with respect to the positioning device. The local sensor 126 may provide the detected measurement data to the adjustment unit 124. The adjustment unit 124 may adjust or correct the stored atmospheric model using the local sensor 126. Alternatively, the local sensor 126 may provide the detected measurement data to the evaluation unit 114. The evaluation unit 114 may determine the position location with inclusion of the measurement data provided by the local sensor 126.

The measurement data provided by the local sensor 126 may be used in addition to or as an alternative to the atmospheric correction data received by the receiver 112 in order to achieve more accurate positioning.

Alternatively, the local sensor may also be situated outside the positioning device, and the detected measurement data transmitted to the positioning device via a communication interface.

In other words, a measurement-based global air pressure, humidity, and/or temperature model in the form of the atmospheric correction data is distributed via navigation data channels which allow the receivers to adjust or correct an installed approximate model. A local air pressure sensor, humidity sensor, and/or temperature sensor may be used for fine tuning.

Thus, for example, tropospheric corrections in near-real time may be distributed directly via GNSS data channels. For this purpose a correction grid which is adjusted in near-real time, for example within hours, may be compactly embedded in a navigation data stream or offered through an optionally fee-based additional service. Alternatively, the locations, dimensions, and deviation values for air pressure, temperature, and/or humidity may be offered by the standard approximate model.

Positioning methods carried out in the described positioning devices may be provided to the positioning devices in the form of a computer program and carried out by a processor of the positioning devices. The processor can be a microprocessor that executes the computer program, field programmable gate array (FPGA), application specific integrated circuit (ASIC) and/or the like.

The individual exemplary embodiments are described by way of example, and may be adapted to possible operating environments and also advantageously combined with one another. In particular, the transmitters used and the number and design of the positioning signals used may be adapted to the particular GNSS system in which the positioning device according to the invention or the positioning method according to the invention is used. Thus, for example, it is possible that not all of the received positioning signals are used for determining the position location.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A positioning device for a satellite navigation system, comprising:
a receiver that receives atmospheric correction data; and
an evaluation unit that determines a position location on the basis of a plurality of positioning signals, with inclusion of the atmospheric correction data.

2. A positioning device according to claim 1, wherein the evaluation unit uses the atmospheric correction data to compensate for error components of the positioning signals caused by atmospheric influences.

3. A positioning device according to claim 1, wherein the atmospheric correction data contain instantaneous air pressure, humidity, or air temperature data from the troposphere.

4. A positioning device according to claim 1, wherein the receiver receives the atmospheric correction data via a transmission channel which transmits at least one of the plurality of positioning signals.

5. A positioning device according to claim 1, wherein useful data is transmitted via the plurality of positioning signals, and the atmospheric correction data is transmitted via at least one of the plurality of positioning signals.

6. A positioning device according to claim 1, further comprising:
a memory that stores an atmospheric model; and
an adjustment unit that adjusts the atmospheric model on the basis of the atmospheric correction data and that provides an adjusted atmospheric model to the evaluation unit, wherein the evaluation unit determines the position location with inclusion of the adjusted atmospheric model.

7. A positioning device according to claim 1, further comprising:
an air pressure sensor that detects localized air pressure or humidity data, wherein the evaluation unit determines the position location with inclusion of the localized air pressure and/or humidity data.

8. A system for navigation or position determination, comprising:
a plurality of transmitters that emit positioning signals; and
at least one positioning device that comprises
a receiver that receives atmospheric correction data; and
an evaluation unit that determines a position location on the basis of a plurality of positioning signals, with inclusion of the atmospheric correction data.

9. A positioning method for a satellite navigation system, comprising the. steps of:
receiving atmospheric correction data; and
determining a position location from a plurality of positioning signals, with inclusion of the atmospheric correction data.

10. A positioning method according to claim 9, further comprising the steps of:
estimating the probability that a positioning error greater than the alarm barrier is present,
estimating the continuity of the position solution, or
estimating the continuity of the existence of a position solution for which the probability that a positioning error greater than the alarm barrier is present is less than a predetermined risk.

11. A computer program product containing a machine-readable program medium on which a computer program is stored, wherein when the computer program is executed by a processor, the processor:
receives atmospheric correction data; and
determines a position location from a plurality of positioning signals, with inclusion of the atmospheric correction data.
